(19) United States
(12) Patent Application Publication
(10) Pub. No.: US 2024/0300053 A1
(43) Pub. Date: Sep. 12, 2024

(54) DIRECTED ACOUSTIC ENERGY FOR MELT POOL EXCITATION DURING 3D PRINTING

(71) Applicant: Divergent Technologies, Inc., Los Angeles, CA (US)

(72) Inventors: Michael Thomas KENWORTHY, Rancho Palos Verdes, CA (US); Seyedalireza Torbatisarraf, Los Angeles, CA (US)

(21) Appl. No.: 18/601,748

(22) Filed: Mar. 11, 2024

Related U.S. Application Data
(60) Provisional application No. 63/451,189, filed on Mar. 9, 2023.

(51) Int. Cl. B23K 26/342; B22F 10/28; B22F 10/36; B22F 10/50; B23K 37/00; B33Y 10/00; B33Y 30/00; B33Y 50/02

(52) U.S. Cl. CPC B23K 26/342; B22F 10/28; B22F 10/36; B22F 10/50; B23K 37/00; B33Y 10/00; B33Y 30/00; B33Y 50/02

(57) ABSTRACT

Disclosed herein are systems and methods for three-dimensional (3-D) printing a build piece in which a laser beam source generates a laser beam for melting a material at a build plate. Additionally, the systems and methods herein include a directed acoustic energy exciter (DAEE) configured to generate an acoustic energy. A controller can be configured to direct the laser beam at a first location to melt the material into a melt pool to form a portion of a build piece and configured to direct the DAEE to transmit the acoustic energy to the first location.

### CROSS-REFERENCE TO RELATED APPLICATION

This application the benefit of, and right of priority to, U.S. Patent Application No. 63/451,189, entitled “Directed Acoustic Energy for Melt Pool Excitation During 3D Printing,” filed Mar. 9, 2023, the contents of which are expressly incorporated by reference as if fully set forth herein.

### BACKGROUND

### Field

The present disclosure relates generally to additive manufacturing and more particularly, to systems and methods of additive manufacturing including direction of generated acoustic energy.

### Background

When producing build pieces via additive manufacturing, a laser beam is directed at material placed in a build area to selectively melt the material to form a desired melt piece. As the laser beam selectively melts the material, portions of the material vary between melting and cooling before solidification. However, dendrites, deformities, warps, cracks, or other defects can form within the build piece during this process due to the stresses caused by the continuous melting and cooling. Such defects lead to poor quality build pieces.

Accordingly, there is a need for improved systems and methods of additive manufacturing that reduce the formation of defects in produced build pieces caused by stresses from the heating and cooling processes during printing.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In one aspect of the disclosure, a three-dimensional (3-D) printing apparatus is provided. In one or more embodiments, the apparatus includes a build plate configured to accept a material, a laser beam source configured to generate a laser beam, a directed acoustic energy exciter (DAEE) configured to generate an acoustic energy, and a controller configured to direct the laser beam at a first location to melt the material into a melt pool to form a portion of a build piece, and configured to direct the DAEE to transmit the acoustic energy to the first location. In one or more embodiments, the acoustic energy is transmitted to the melt pool. For example, the acoustic energy is transmitted to the melt pool while the melt pool cools and solidifies. In one or more embodiments, the DAEE can be selectively activated over time to transmit the acoustic energy to the first location. In one or more embodiments, the DAEE can vary at least an amplitude or a frequency of the acoustic energy over time. In one or more embodiments, the controller can be further configured to direct the laser beam to a second location. In one or more embodiments, the controller can be further configured to direct the acoustic energy to the second location.

Additionally, in one or more embodiments, the apparatus can include an optical bench. For example, the optical bench can include a laser steering carriage including the laser beam source. In one or more embodiments, the optical bench includes the DAEE.

Additionally, in one or more embodiments, the apparatus can include a magnetic levitator including the DAEE.

Additionally, in one or more embodiments, the apparatus can include a motor assembly to activate and deactivate the DAEE.

In another aspect of the disclosure, a method of additive manufacturing is provided. In one or more embodiments, the method includes depositing a material on a build plate, generating a laser beam by a laser beam source, and generating an acoustic energy by a directed acoustic energy exciter (DAEE). Further, in one or more embodiments, the method includes directing, by a controller, the laser beam source toward a first location to melt the material into a melt pool to form a portion of a build piece, and directing, by the controller, the DAEE to transmit the acoustic energy to the first location. For example, the method can include selecting the first location by a controller based on a vector list. In one or more embodiments, the method further includes transmitting the acoustic energy to the melt pool. For example, the acoustic energy can be transmitted to the melt pool while the melt pool cools and solidifies. In one or more embodiments, the method includes selectively activating the DAEE over time to transmit the acoustic energy to the first location. Moreover, in one or more embodiments, the method includes varying at least an amplitude or a frequency of the acoustic energy over time.

Additionally, in one or more embodiments, the method includes an energy profile of the acoustic energy that matches an energy profile of the laser beam.

Additionally, in one or more embodiments, the method includes steering the laser beam source by a steering carriage.

Additionally, in one or more embodiments, the method includes steering the DAEE by a steering carriage, magnetically levitating the DAEE, or electronically filtering the acoustic energy.

Additionally, in one or more embodiments, the method includes directing, by the controller, the laser beam source toward a second location to melt the material into a melt pool to form a portion of a build piece, and directing, by the controller, the DAEE to transmit the acoustic energy to the second location.

It is understood that other aspects will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of the concepts described herein will now be presented in the detailed description by way of example, and not by way of limitation, in the accompanying drawings, wherein:

FIGS. 1A-1D illustrate respective side views of an exemplary L-PBF system capable of directing generated acoustic energy during different stages of operation according to one or more embodiments herein.

FIG. 2 illustrates a side view of an exemplary L-PBF system capable of directing generated acoustic energy during different stages of operation according to one or more embodiments herein.

FIG. 3 illustrates graphic representations of acoustic energy generated by a DAEE at different frequencies according to one or more embodiments disclosed herein.

FIG. 4 is a flowchart of an exemplary method of additively manufacturing a build piece in a L-PBF apparatus.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, to avoid obscuring the various concepts presented throughout this disclosure.

While this disclosure is generally directed to laser-based PBF (L-PBF) systems for additive manufacturing (i.e., three-dimensional printing), it will be appreciated that such L-PBF systems may encompass a wide variety of additive manufacturing techniques. Thus, the L-PBF process may include, among others, the following printing techniques: Direct metal laser sintering (DMLS), Selective laser melting (SLM) and Selective laser sintering (SLS). Still other PBF processes to which the principles of this disclosure are pertinent include those that are currently contemplated or under commercial development. While the specific details of each such process are omitted to avoid unduly obscuring key concepts of the disclosure, it will be appreciated that the claims are intended to encompass such techniques and related structures.

L-PBF systems can produce metal and polymer structures (referred to as build pieces) with geometrically complex shapes, including some shapes that are difficult or impossible to create using conventional manufacturing processes. L-PBF systems create build pieces layer-by-layer, i.e., slice-by-slice. Each slice may be formed by a process of depositing a layer of powder and fusing (e.g., melting and cooling) areas of the powder layer that coincide with the cross-section of the build piece in the slice (e.g., a melt pool). The process may be repeated to form the next slice of the build piece, and so on, until all the layers are deposited and the build piece is complete.

In conventional L-PBF systems, the path a laser takes across the top layer of powder (i.e., the scan pattern) is typically in patterns of parallel lines drawn back and forth across the current build layer. The orientation of the lines can vary in patches or be uniform for an entire layer. The L-PBF system then moves to the next layer and continues directing the laser beam in a pattern of stripes. For each layer, conventional L-PBF systems apply a constant energy profile.

However, during formation of the build piece, there may be operational flaws that occur in the build piece as a result of the laser melting and cooling or solidification process. In particular, it is desirable to limit the formation of dendrites (e.g., characteristic tree-like structures of crystals that grow and propagate as molten metal solidifies) in the build piece, as dendrites lead to micro and/or macro cracks in the resulting build piece. Conventionally, to address dendrites, cracking, or other similar physical flaws, the build process must be stopped, the problem fixed such as by breaking up the dendrites before larger cracks can form, or a new build started. This can delay the additive manufacturing process and result in wasted material if a build piece must be scrapped due to excessive cracking.

Aspects of the present disclosure are directed to advantageous additive manufacturing apparatuses and methods in which a build piece is produced by performing laser melting and cooling of a material while also generating acoustic energy by a directed acoustic energy exciter (DAEE) that is focused toward the melt pool that the laser beam is creating to form the current portion of the build piece. In other words, during the laser scanning process, acoustic energy produced by a DAEE is directed at the locations where powder fusing and cooling of a build piece is occurring. By stimulating the melt pool with this acoustic energy during the cooling and solidification process, the formation of dendrites in certain alloy systems may be disrupted, thereby preventing the formation of cracks. For example, certain alloys that may be used in additive manufacturing may have wide bands of solidification that take a long time to solidify, thereby providing more opportunities for cracks to appear in the manufactured build piece because not all portions of the build piece are solidifying at the same time or rate. The ability to print crack-sensitive materials via additive manufacturing while creating fewer or smaller-sized dendrite instances that limit the chances of cracking in real-time is thus a major advantage.

As provided herein, a DAEE can include a motor assembly, a voice coil, a suspension system, electrical connection terminals, and a coupling plate or ring that joins the voice coil to the mounting surface where the DAEE is located. Using these components, a DAEE can directionally generate acoustic energy into a surface, effectively radiating sound. Unlike conventional loudspeakers which use a frame and a cone diaphragm to radiate sound, a DAEE includes a rigid connection with the surface the DAEE is mounted on to direct the acoustic energy generated. The inertia of the mass of the DAEE serves to apply force from the voice coil to the mounting surface, which flexes and directs the acoustic energy toward an intended location. A DAEE is typically placed centrally on the mounting surface to generate evenly distributed acoustic energy, though placing the DAEE elsewhere or introducing multiple DAEEs at different locations may be implemented depending on the amplitude and frequency of the waves of acoustic energy desired to be generated.

The mounting surface of the DAEE is typically a thin, lightweight sheet of material that has high compressive strength and high bending strength. For example, the mounting surface could be aluminum, syntactic foam, fiberglass, or other similar materials. The thicker and heavier the mounting surface, the larger and more powerful DAEE is necessary to generate similar amounts of acoustic energy as thinner or lighter mounting surface materials. A DAEE may be mounted to such surfaces using by bolts, screws, adhesive pads, glue, tape, or other conventional fastening methods.

In one or more embodiments, the DAEE configuration is chosen based on the spot size of the laser beam on the melt pool. For example, a laser beam spot target may be 0.5 m, and the DAEE configuration should be chosen so that the acoustic energy is directed to spread to approximately that width at the spot target. Application of acoustic energy may also be isolated to only portions of the build piece geometry that require it. For example, not all materials used in additive manufacturing have the same risk of cracking. Some materials may only crack when processed in a relatively thick region, or under other pressure, temperature, or other physical circumstances.

Additionally, the DAEE configuration and steering may be coincident with the areas of the powder bed being processed by the laser optics. In other words, the DAEE configuration can be chosen to account for the scanning speed of the laser beam. For example, a laser beam may scan the powder layer deposited on the build plate in the powder bed at a rate between 0.5-2.5 m/s. The speed of the acoustic energy application should approximately match the steering speed of the lasers.

In one or more embodiments, the DAEE configuration can be chosen to match the profile of the generated acoustic energy to the energy profile of the laser beam. For example, the generated acoustic energy waveform has an amplitude and a frequency that could be varied based on the corresponding amplitude or frequency of the laser beam or based on the movement of the laser beam around the powder bed.

In one or more embodiments, the application of acoustic energy generated by the DAEE may be time-phased based on a variety of melt pool characteristics and interrelated variables that capture the time-temperature history of the voxel of the powder bed being scanned.

In one or more embodiments, the laser beam source and laser shaping components are contained within an optical bench in the L-PBF system. In one or more embodiments, the DAEE is also contained within the optical bench. For example, the DAEE might be contained in a top plate, side walls or any combination thereof of the optical bench. However, the DAEE is not required to be contained within the optical bench and may be located wherever necessary to be able to direct the generated acoustic energy to the desired location in the powder bed without disrupting the other components of the system. For example, if the DAEE is located too near to the laser beam optics, the generated energy could shake the components and adversely affect the quality of the generated laser beam. Accordingly, the DAEE is typically isolated from the laser beam source. In one or more embodiments, the DAEE is located within the build plate.

Depending on the packaging arrangement of the DAEE, the DAEE can be directed via various DAEE carriage systems. For example, the DAEE can be directed by a physical steering system like a gantry steering system or a motor assembly. In addition or in other embodiments, the DAEE can be magnetically levitated, or directional audio devices may be coupled to the DAEE to direct the generated acoustic energy. In one or more embodiments, the direction and sequence of the generated acoustic energy can be programmed. For example, the DAEE can be configured to receive a vector list representing the direction and orientation in space the acoustic energy should be provided during the laser scanning sequence. This vector list can account for the current layer of the build piece that is being manufactured, as well as additional layers that will be processed.

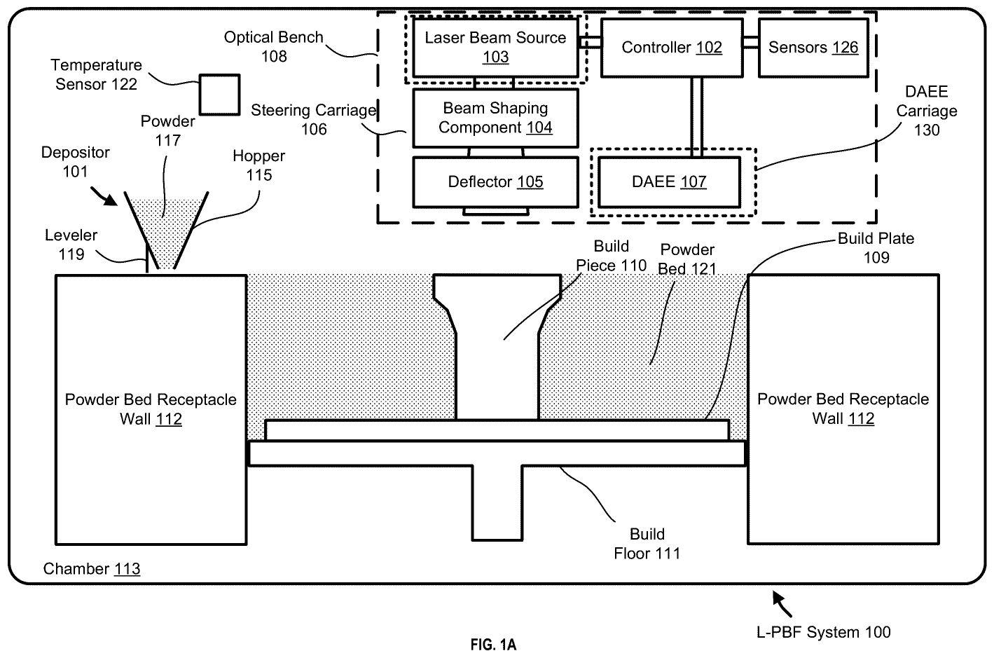

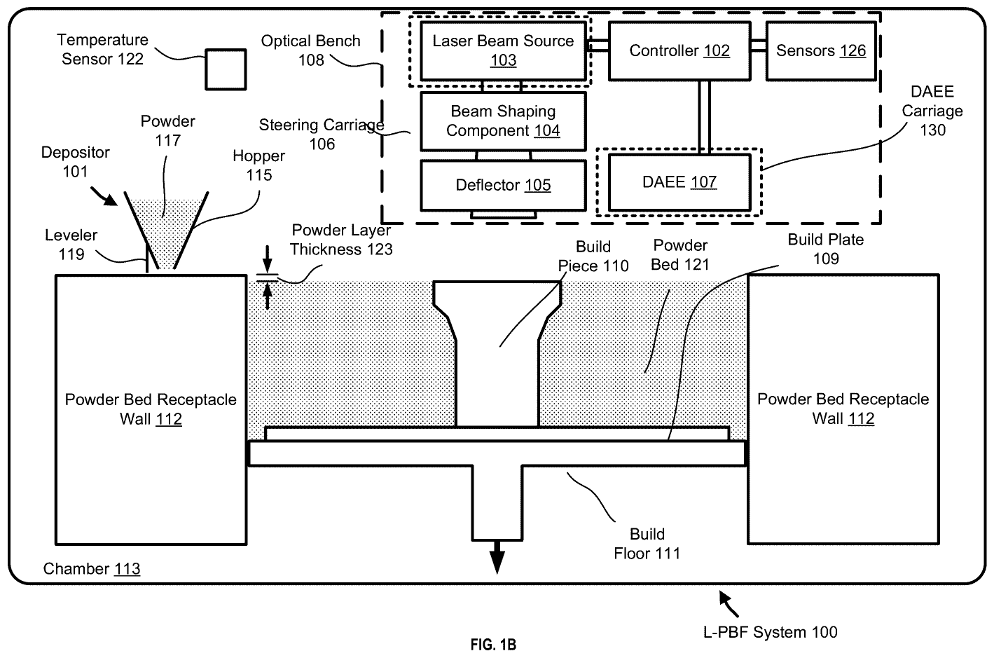

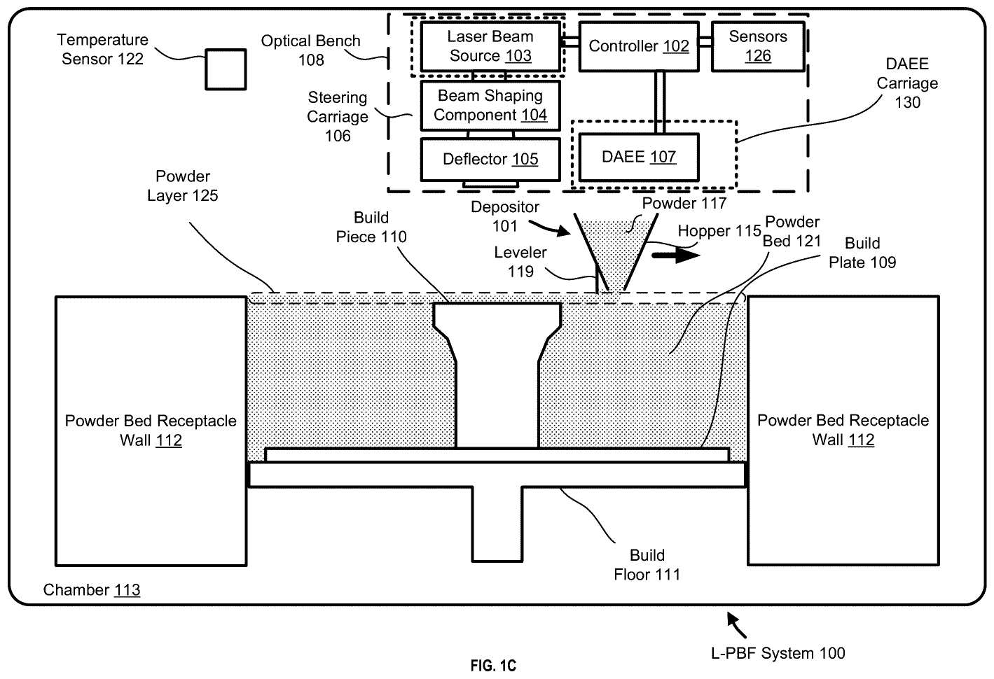

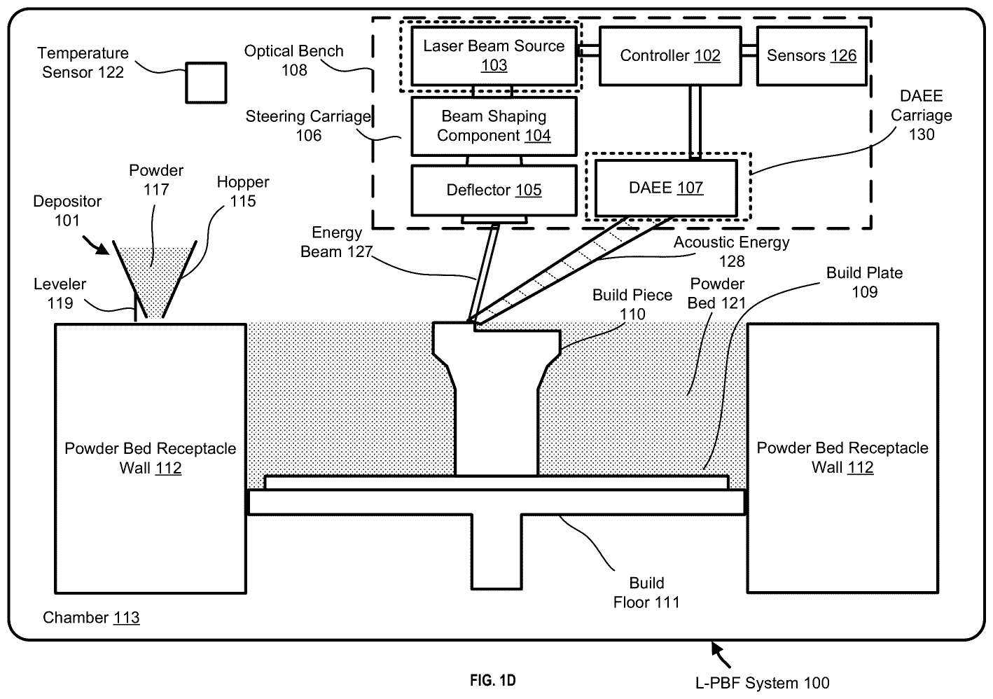

FIGS. 1A-D illustrate respective side views of an exemplary laser-based PBF (L-PBF) system 100 during different stages of operation. As noted above, the embodiment illustrated in FIGS. 1A-D is one of many suitable examples of a L-PBF system employing principles of this disclosure. It should also be noted that elements of FIGS. 1A-D and the other figures in this disclosure are not necessarily drawn to scale but may be drawn larger or smaller for the purpose of better illustration of concepts described herein. L-PBF system 100 may include a depositor 101 that may deposit each layer of powder material, a controller 102, a laser beam source 103 that may generate a laser beam, a beam shaping component 104 that may shape the laser beam according to a selected beam geometry, a deflector 105 that may apply the laser beam in the form of the selected beam geometry to fuse the powder material, a steering carriage 106 that may contain the laser beam source (e.g., laser beam source 103), a directed acoustic energy exciter (DAEE) 107, an optical bench 108, and a build plate 109 that may support one or more build pieces, such as a build piece 110. In one or more embodiments, the optical bench 108 includes the steering carriage 106 containing the laser beam source 103. In one or more embodiments, the optical bench 108 includes the DAEE 107. In one or more embodiments, the DAEE 107 is located adjacent to, embedded in, or outside of, the optical bench 108. For example, the DAEE 107 may be located within the top plate or side walls of the optical bench 108.

The controller 102 or other processing system may coordinate the L-PBF additive manufacturing process. The controller 102 can be a central processing unit or other type of processor as is known. In one or more embodiments, the controller 102 may be operatively coupled to the positioning systems controlling the L-PBF system 100 based structures (e.g., depositor 101, laser beam source 103, beam shaping component 104, steering carriage 106, DAEE 107, etc.). In this way, an organized timing of operations can be carefully coordinated by a central controller.

While the laser beam source 103 and the beam shaping component 104 have been generally identified as separate components, in some exemplary embodiments the functionality of both components may be included as part of a single integrated structure without departing from the scope of the disclosure.

In one or more embodiments, the steering carriage 106 contains the laser beam source 103 within or coupled to a steering system or a Gantry system. In one or more embodiments, the steering carriage further contains the beam shaping component 104 and/or the deflector 105.

The L-PBF system 100 may also include a build floor 111 positioned within a powder bed receptacle. The walls of the powder bed receptacle 112 may generally define the boundaries of the powder bed receptacle, which is defined between the walls 112 from the side and a portion of the build floor 111 below. The build floor 111 may progressively lower build plate 109 such that depositor 101 may deposit a next layer of powder material. The L-PBF system 100 may additionally include a chamber 113 that may enclose the other components of L-PBF system 100 (e.g., controller 102, laser beam source 103, beam shaping component 104, deflector 105, steering carriage 106, DAEE 107), thereby protecting such other components, enabling atmospheric and temperature regulation and mitigating contamination risks. Further, the L-PBF system 100 may include a temperature sensor 122 to monitor the atmospheric temperature, the temperature of the powder 117 and/or components of the L-PBF system 100. Depositor 101 may include a hopper 115 that contains a powder 117, such as a metal powder, for example. The depositor 101 may also include a leveler 119 that may level the top of each layer of deposited powder (see e.g., powder layer 125 of FIG. 1C) by displacing deposited powder 117 above a predefined layer height (e.g., corresponding to powder layer thickness 123 of FIG. 1B).

Referring specifically to FIG. 1A, this figure shows L-PBF system 100 after a slice of build piece 110 has been fused, but before the next layer of powder 117 has been deposited. In fact, FIG. 1A illustrates a time at which L-PBF system 100 has already deposited and fused slices in multiple layers, e.g., 150 layers, to form the current state of build piece 110, e.g., formed of 150 slices. The multiple layers already deposited have created a powder bed 121, which includes powder that was deposited but not fused.

FIG. 1B shows L-PBF system 100 at a stage in which build floor 111 may lower by a powder layer thickness 123. The lowering of build floor 111 causes build piece 110 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 110 and powder bed 121.

FIG. 1C shows L-PBF system 100 at a stage in which depositor 101 is positioned to deposit powder 117 in a space created over the top surfaces of build piece 110 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness of substantially equal to the powder layer thickness 123 (see FIG. 1B). Thus, the powder 117 in L-PBF system 100 may be supported by a powder material support structure, which may include, for example, a build plate 109, a build piece 110, a build floor 111, walls 112, and the like. It should be noted that the illustrated thickness of powder layer 125 (e.g., powder layer thickness 123 of FIG. 1B) may be greater than an actual thickness used for the example involving 150 previously deposited layers discussed above with reference to FIG. 1A.

In one or more embodiments, information about the powder layer 125 can be obtained by one or more sensors 126 of the L-PBF system 100. Sensors 126 may capture information about powder layer 125 and other conditions within the chamber 113. For example, sensors 126 can collect information regarding the amount of powder in portions of the powder layer, the temperature of the layer at different portions of the powder layer, and other (including depth), or other characteristics of the layer. In one or more embodiments, sensors 126 are operatively coupled to controller 102 such that information collected by the sensors can be processed by the controller. In one or more embodiments, the controller 102 can receive information dividing the layer of powder material into a plurality of tiles or areas of the layer. In one or more embodiments, a tile energy profile is associated with each of the tiles. The tiles can form a grid, can overlap adjacent tiles, or be other shapes and sizes as necessary for the build piece.

In automated embodiments where temperature is closely monitored (e.g., using temperature sensors adjacent to the build piece), the order of tiles for printing may occur dynamically on the fly. That is, the controller may determine the order after printing has begun, based on the temperature of the deposited layers, the intended geometry of the finished build piece, or other factors.

FIG. 1D illustrates the L-PBF system 100 generating a next slice in build piece 110 following the deposition of powder layer 125 (FIG. 1C). Referring to FIG. 1D, the laser beam source 103 may generate a laser beam. The beam shaping component 104 may be used to vary the geometric shape of the laser beam to be in the form of a line, a square, a rectangle, or other two-dimensional shape. In some aspects, the beam shaping component 104 may shape the laser beam through phase plates and free spacing propagation. The beam shaping component 104 may include multiple diffracting, reflecting and refracting apparatus, such as diffractive beam splitters, diffractive diffusers, phase plates, lenses, mirrors, or other optical elements. Changes in the size and geometry of the laser beam 127 may, for example, be achieved by motorized displacement of the optical elements of beam shaping component 104. In one or more embodiments, the controller 102 can execute instructions to be configured to control the beam shaping component 104 to adjust a beam energy profile associated with the laser beam source 103 to correspond to a tile energy profile of a first tile of the plurality of tiles in the powder layer 125 to obtain a first beam energy profile. In some aspects, the geometry of the beam shape may be set according to the build piece 110. The geometry of the beam shape may be modified on a tile-by-tile or slice-by slice basis based on the geometry of the build piece to reduce scan time, achieve residual stress or particular microstructure of the build piece for a particular tile, slice, or layer. In some aspects, the geometry of the beam shape may also be modified mid-tile, mid-layer, or even continuously throughout the scanning of the build piece 110.

Thereafter, the controller 102 can be configured to apply a pulse of the laser beam with the first beam energy profile to the first tile to fuse a portion of the build piece corresponding to the first tile. Deflector 105 may apply the laser beam 127 in the selected geometric shape to fuse the identified first tile in build piece 110. In various embodiments, the deflector 105 may include one or more gimbals and actuators that can rotate and/or translate the laser beam source 103 and/or beam shaping component 104 to position the laser beam 127. In various embodiments, laser beam source 103, beam shaping component 104 and/or deflector 105 can modulate the laser beam, e.g., turn the laser beam on and off as the deflector scans such that the laser beam is applied only in the appropriate areas of the powder layer. For example, in various embodiments, the laser beam can be modulated by a digital signal processor (DSP).

In some aspects, the controller 102 can be configured to control the beam shaping component 104 to adjust the beam energy profile to correspond to a tile energy profile of a second tile of the plurality of tiles to obtain a second beam energy profile. For example, the second beam energy profile is different than the first beam energy profile. Thereafter, the controller 102 can be configured to apply a pulse of the laser beam source 103 with the second beam energy profile to the second tile to fuse a portion of the build piece corresponding to the second tile.

In one or more embodiments, the beam energy profile can be adjusted based on a customized time profile. In other words, the controller can configure the laser beam to activate for a duration of t₀ to t₁ at an initial power, then from a duration of t₁ to t₂ at a revised power. For example, the controller can configure the laser beam to activate at a particular tile at 400 watts for a selected duration, then activate at that same tile at 600 watts for a different duration. Further, the controller can configure the system to scan the laser across the tile as the applied laser beam power is varied. In this way, the systems herein can time vary the energy input to achieve a desired microstructure in the build piece.

As shown in FIG. 1D, much of the fusing of the tiles of powder layer 125 occurs in areas of the powder layer that are on top of the previous slice, i.e., previously fused powder. An example of such an area is the surface of build piece 110. The fusing of the powder layer in FIG. 1D is occurring over the previously fused layers characterizing the substance of build piece 110.

In addition, FIG. 1D illustrates the application of acoustic energy 128 generated by the DAEE 107 of the L-PBF system 100 to the tile that the laser beam is being applied to fuse a portion of the build piece corresponding to the first time. As the laser beam scans along the tiles comprising the current layer, melting and cooling the powder material to form portions of the build piece 110, the acoustic energy 128 may be focused in conjunction with the laser beam to disrupt dendrite formation in the build piece. The acoustic energy 128 does this by vibrating the portion of the build piece being manufactured, thereby limiting the ability of dendrites to form in the first instance and minimizing crack formation in the final build piece. The application width, power, amplitude, frequency, and direction of the acoustic energy 128 may be varied by the DAEE over time or depending on the location on the build piece to minimize crack formation. For example, as the laser beam is activated or deactivated while oriented to the first tile to fuse a portion of the build piece, the tile will be in various states of melting or cooling. Advantageously, the acoustic energy 128 may be applied when the portion of the build piece in a melt pool stage such that the material is not fully solid or liquid.

In one or more embodiments, the acoustic energy 128 can be adjusted based on a customized time profile. In other words, the controller 102 can configure the DAEE 107 to activate for a duration of t₀ to t₁ at an initial amplitude and/or frequency, then from a duration of t₁ to t₂ at a revised amplitude and/or frequency. Additionally, the controller 102 can configure the DAEE 107 to activate for a duration of t₀ to t₁ at an initial amplitude and/or frequency, then deactivate from a duration of t₁ to t₂, and reactivate at the initial or a revised amplitude and/or frequency om a duration of t₂ to t₃. Further, the controller 102 can configure the system to direct the acoustic energy 128 across the tile as the applied laser beam power is varied. In this way, the systems herein can time vary the acoustic energy input to achieve a desired microstructure in the build piece.

In one or more embodiments, the acoustic energy 128 can be adjusted based on a customized fusion pattern. In other words, the controller 102 can configure the DAEE 107 to activate at certain tiles or vectors or portions thereof corresponding to portions of the build piece 110 and deactivate at certain tiles or vectors or portions thereof to vary the acoustic energy input to achieve a desired microstructure in the build piece depending on location. In one or more embodiments, an energy profile of the acoustic energy 128 matches an energy profile of the laser beam generated by the laser beam source 103.

In one or more embodiments, the DAEE 107 may be contained within a DAEE carriage 130 and configured by the controller 102 to adjust the direction the acoustic energy 128 is transmitted. For example, the DAEE carriage 130 may be a physical steering system like a gantry steering system or a motor assembly, or can be a magnetic levitator. In this way, the DAEE 107 can transmit the acoustic energy 128 to different locations during manufacture of the build piece 110.

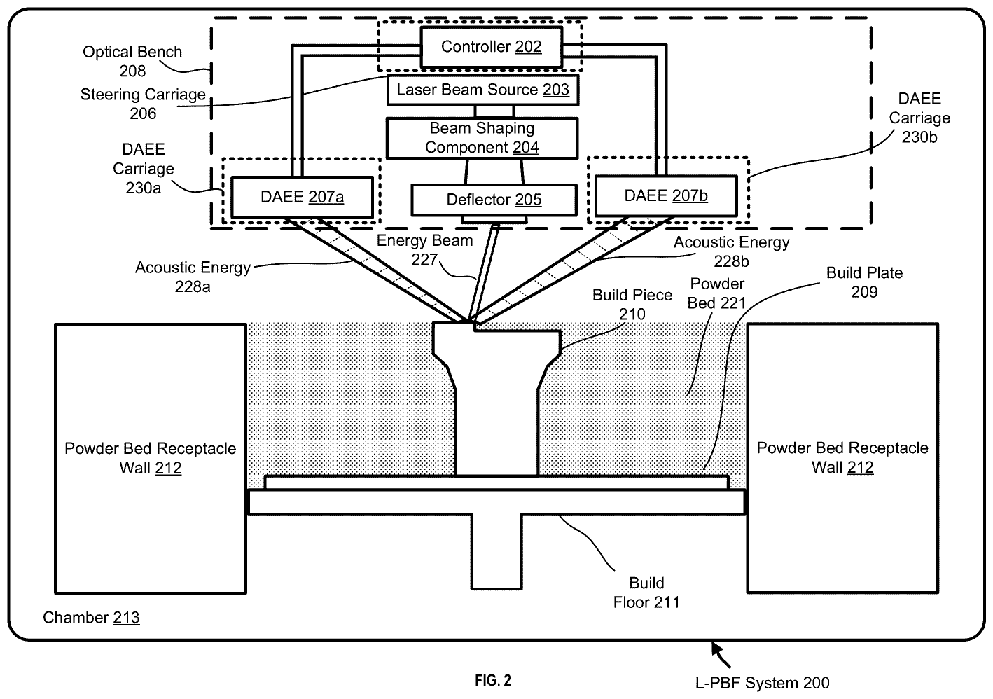

With reference to FIG. 2, a side view of an exemplary laser-based PBF (L-PBF) system 200 during operation is illustrated. As noted above, the embodiment illustrated in FIGS. 1A-D is one of many suitable examples of a L-PBF system employing principles of this disclosure. The system 200 shares many elements as described elsewhere herein (e.g., controller, 202, laser beam source 203, beam shaping component 204, deflector 205, steering carriage 206, optical bench 208, etc.). In addition, the system 200 includes two DAEE 207a, 207b respectively contained within DAEE carriages 230a, 230b. Each of the DAEE 207a, 207b may be activated as described elsewhere herein to direct two beams of acoustic energy 228a, 228b toward the portion of the build piece 210 being produced. The DAEE 207a, 207b may be configured by the controller 202 to selectively activate for different durations, amplitudes, or frequencies to generate the desired acoustic energies 228a, 228b. Additionally, the DAEE 207a, 207b may be configured to direct acoustic energies 228a, 228b to separate melt locations during build piece 210 manufacture.

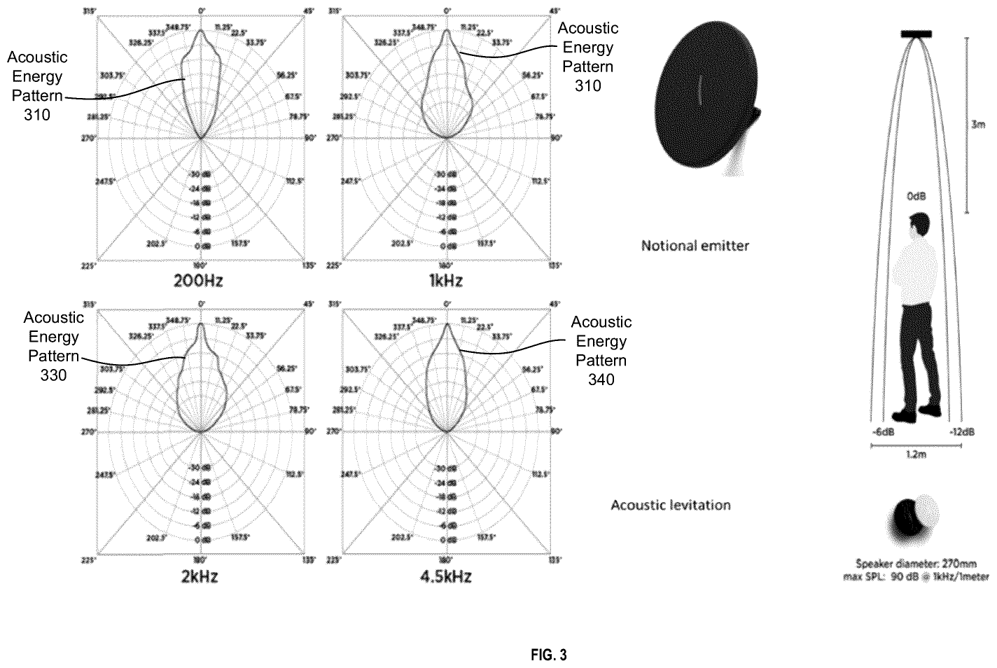

FIG. 3 illustrates different acoustic energy arrangements that a DAEE may produce according to one or more embodiments herein. The illustrations herein show the acoustic energy pattern produced when the DAEE is activated at different frequencies. For example, a DAEE operating at 200 Hz forms an exemplary acoustic energy pattern 310, 1000 Hz forms an exemplary pattern 320, 2000 Hz forms an exemplary pattern 330, and 4500 Hz forms an exemplary pattern 340.

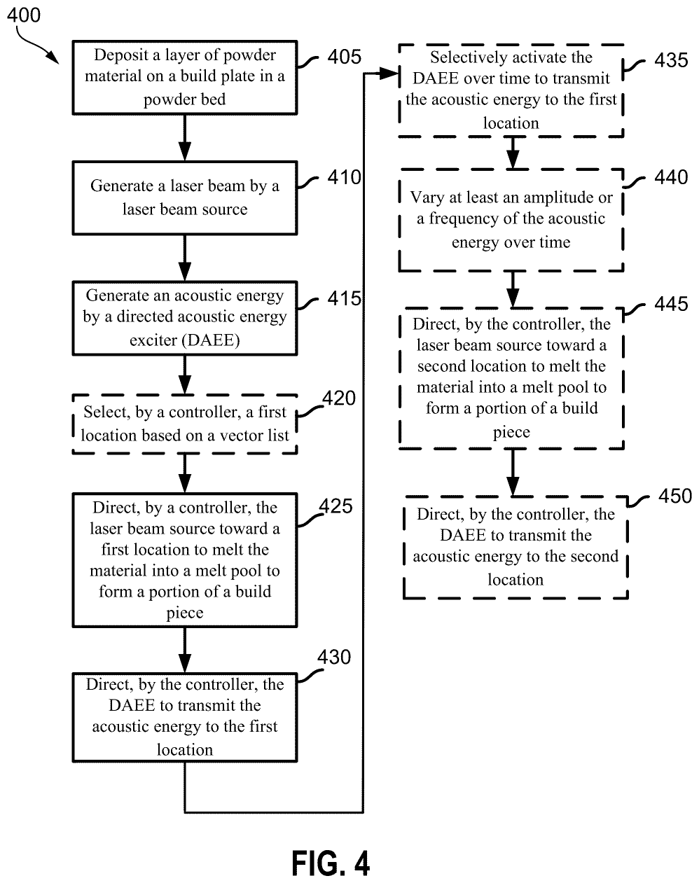

FIG. 4 is a flowchart of an exemplary method 400 of additively manufacturing a build piece in a L-PBF apparatus including directing generated acoustic energy according to the disclosure herein. Referring first to step 405, the method 400 includes depositing a layer of powder material on a build plate in a powder bed. The layer of powder material may be deposited by a depositor, for example. Further, the layer of powder may be subdivided into a plurality of tiles (i.e., portions or areas of the build layer) each having a width, length, and depth. At step 410, a laser beam source is configured to produce a laser beam. This laser beam includes an associated beam energy profile, which may be adjusted by a beam shaping component. Thereafter, the method 400 continues at step 415 by generating an acoustic energy by a directed acoustic energy exciter (DAEE). The acoustic energy includes a corresponding amplitude and frequency.

In one or more embodiments, the method 400 selects, by a controller, a first location based on a vector list, step 420. The first location may be at a portion of the build layer for a build piece to be additively manufactured. The vector list may set forth the order of tiles or portions of the build layer that are to be processed by the L-PBF apparatus by laser beam and acoustic energy application to form the build piece.

At step 425, the method 400 directs, by a controller, the laser beam source toward a first location to melt the material into a melt pool to form a portion of the build piece. This first location may be the location selected according to the pre-determined vector list in step 420, or may be selected according to dynamic, on the fly adjustments made by the controller according to properties measured during manufacture, such as a measured pressure or temperature at the build layer, or if dendrites or cracking are identified in the build piece. In one or more embodiments, the laser beam source is directed toward the first location by a steering carriage. For example, the steering carriage can be a gantry system. Thereafter, the controller directs the DAEE to transmit the acoustic energy to the first location, step 430. In one or more embodiments, the laser beam and the acoustic energy are directed toward the first location at the same time. In one or more embodiments, the laser beam and the acoustic energy are directed toward the first location for the same duration. the laser beam and the acoustic energy are directed toward the first location at different times or for different durations.

Optionally, the method 400 continues at step 435 by selectively activating the DAEE over time to transmit the acoustic energy to the first location. For example, the DAEE can be configured to activate from a time t₀ to t₁, then deactivate from t₁ to t₂, then activate again thereafter. Additionally, the method 400 can vary at least an amplitude or a frequency of the acoustic energy over time, step 440. The amplitude or frequency can be varied to apply more or less force to the powder layer where the melt pool is to minimize the chances of cracking to the build piece.

Optionally, the method 400 continues at step 445 by directing, by the controller, the laser beam source toward a second location to melt the material into a melt pool to form a portion of a build piece. Additionally, the method 400 may direct, by the controller, the DAEE to transmit the acoustic energy to the second location, step 450. In this way, these steps permit the method to perform laser fusion and acoustic energy application to multiple locations in a powder layer during the build piece manufacture process.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other support structures and systems and methods for removal of support structures. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A three-dimensional (3-D) printing apparatus comprising:
a build plate configured to accept a material;
a laser beam source configured to generate a laser beam;
a directed acoustic energy exciter (DAEE) configured to generate an acoustic energy; and
a controller configured to direct the laser beam at a first location to melt the material into a melt pool to form a portion of a build piece, and configured to direct the DAEE to transmit the acoustic energy to the first location.

2. The apparatus of claim 1, wherein the acoustic energy is transmitted to the melt pool.

3. The apparatus of claim 2, wherein the acoustic energy is transmitted to the melt pool while the melt pool cools and solidifies.

4. The apparatus of claim 1, wherein the DAEE is selectively activated over time to transmit the acoustic energy to the first location.

5. The apparatus of claim 1, wherein the DAEE varies at least an amplitude or a frequency of the acoustic energy over time.

6. The apparatus of claim 1, wherein the controller is further configured to direct the laser beam to a second location.

7. The apparatus of claim 6, wherein the controller is further configured to direct the acoustic energy to the second location.

8. The apparatus of claim 1, further comprising an optical bench.

9. The apparatus of claim 8, wherein the optical bench includes a laser steering carriage including the laser beam source.

10. The apparatus of claim 8, wherein the optical bench includes the DAEE.

11. The apparatus of claim 1, further comprising a magnetic levitator including the DAEE.

12. The apparatus of claim 1, further comprising a motor assembly to activate and deactivate the DAEE.

13. A method of additive manufacturing comprising:
depositing a material on a build plate;
generating a laser beam by a laser beam source;
generating an acoustic energy by a directed acoustic energy exciter (DAEE);
directing, by a controller, the laser beam source toward a first location to melt the material into a melt pool to form a portion of a build piece; and
directing, by the controller, the DAEE to transmit the acoustic energy to the first location.

14. The method of claim 13, further comprising transmitting the acoustic energy to the melt pool.

15. The method of claim 14, wherein the acoustic energy is transmitted to the melt pool while the melt pool cools and solidifies.

16. The method of claim 13, further comprising selectively activating the DAEE over time to transmit the acoustic energy to the first location.

17. The method of claim 13, further comprising varying at least an amplitude or a frequency of the acoustic energy over time.

18. The method of claim 13, wherein an energy profile of the acoustic energy matches an energy profile of the laser beam.

19. The method of claim 13, further comprising selecting the first location by a controller based on a vector list.

20. The method of claim 13, wherein directing the laser beam source toward the first location comprises steering the laser beam source by a steering carriage.

21. The method of claim 13, wherein directing the DAEE to transmit the acoustic energy to the first location comprises steering the DAEE by a steering carriage, magnetically levitating the DAEE, or electronically filtering the acoustic energy.

22. The method of claim 13, further comprising:
directing, by the controller, the laser beam source toward a second location to melt the material into a melt pool to form a portion of a build piece; and
directing, by the controller, the DAEE to transmit the acoustic energy to the second location.
